(19) United States
(12) Patent Application Publication
(10) Pub. No.: US 2018/0093917 A1
(43) Pub. Date: Apr. 5, 2018

(54) MOLDING COMPOSITE AND METHOD OF MAKING MOLDED PART

(71) Applicant: Raytheon Company, Waltham, MA (US)

(72) Inventors: Michael Ushinsky, Irvine, CA (US); Sunder S. Rajan, Anaheim, CA (US); Scott T. Turner, Redondo Beach, CA (US); Isaac C. Chen, Alhambra, CA (US)

(21) Appl. No.: 15/283,673

(22) Filed: Oct. 3, 2016

(51) Int. Cl. C03C 8/14; B28B 3/00

(52) U.S. Cl. CPC C03C 8/14; B28B 3/00

(57) ABSTRACT

A molding composite includes mica flakes and a eutectic glaze. The composite allows making of lead-free parts for use in a variety of situations, such as electrical insulators for supporting electrically-conductive parts, such as electrodes, for electrical devices. The molded composite material can be used mold around such electrically-conductive parts, supporting them and/or providing hermetic seals around the parts. Other possible uses include substrates for electronic circuits, and housings for parts, such as electro-optical parts. The molding composite is heated under elevated pressure to liquefy the eutectic glaze, causing it to coat the mica flakes. After the composite is put into a desired shape it is solidify, for example by compressing the molding composite at a constant temperature until the eutectic glaze solidifies, followed by cooling of the molding composite.

### FIELD OF THE INVENTION

The invention is in the field of molding composites for forming molding composites that include mica, and parts of such composites and methods for making such parts.

### DESCRIPTION OF THE RELATED ART

Glass-bonded-mica composite materials have been manufactured by mixing and fusing together at moderately high temperature and under high pressure, finely powdered electrical quality glass and precisely defined (natural or synthetic) mica. The resulting stone-like, dense mica-glass composite (for example having a density of from about 2.7 to about 3.1 g/cm³) inherits electro- and thermo-insulating advantages of both constituents. Among the preferred glasses used are silica-lead oxides, as well as the lead-free low-temperature-melting glasses. Examples are Crystex LLC grades, MM1301 (leaded) and MM561 (lead-free) mica-glass molding grades. Components made from mica-glass can be further machined, such as with standard carbide tools and water cooling. These moldable grades do not require firing or sintering after molding (essentially one step process after pre-forming), which make them similar to the processing of thermoplastics. These materials can accommodate metal inserts during molding.

The presence of lead oxide in the MM1301 or similar lead-oxide-containing glasses eases the mica-glass composite flow when molding and this is the advantage of MM1301 and similar materials. Unfortunately the lead dust exposure is not desirable in any fabrication process due to the recently established environmental and public health regulations. The impact of lead-contaminated industrial products on the health of people is a matter of great social concern. The recently implemented alternative lead-free single- or multi-oxide materials are often characterized by similar or higher processing temperatures. However, the lead-free glass materials are much more viscous than their lead-based predecessors and that in turn has a huge effect on their flow and molding characteristics, including co-molding with metal parts. The lead-free materials also tend to have a narrower working range of temperature over which they remain viscous enough to flow inside the form and be molded. These differences increase the complications accompanying the molding process for the lead-free materials. One example of a lead-free alternative to MM1301 composition is the MM561 composite mentioned earlier. The MM1301 single-oxide powders are blended with mica flakes and its lowest processing temperatures do not exceed 400° C., with process temperatures where the constituents remain in solid state, not resulting in melting of the mica and/or glass phases. Although there is some process similarity to use of MM1301, parts molded from MM561 material exhibit cracking as compared with crack-free parts molded from legacy composition MM1301. In the case of compression molding, they often require a higher molding pressure that is essential for the higher viscosity blends at high temperature. As a result a residual stress is also higher as compared with MM1301. Additionally many lead-free glass materials exhibit larger thermal mismatch with mica, therefore causing the increased intrinsic stresses in the molded composites. In addition, compression molding of blended glass and mica particulates presents difficulties and requires high overall pressures, complicating design of mold forms, and requiring thick walls and gates.

### SUMMARY OF THE INVENTION

While use of mica-glass as an insulating material is known, some such materials contain lead, and numerous difficulties have been encountered in making lead-free moldable composites having strong dielectric response, and therefore being application for use in opto-electronic, laser crystal, and microwave components (to give a few examples). Among the examples of possible applications are dielectric Q-switching housings for lithium niobate crystals. These housings often include several metal terminations and pins that are co-molded with mica and glass. The moldable mica-glass composites can be also used as dielectric circuit boards and dielectric parts of different electronic components. Although new composites can prevent damage of the mating opto-electronic and laser crystal components, they often have high residual stress and cracking further causing the electric failures. The difference in thermal expansions of mica-glass and metal units also contributes to mechanical and electrical failures of co-molded devices. The molding process for the commercial lead-free substitutes includes additional complications associated with the excessive viscosity of mica-glass blends at the elevated temperatures. Thus there is a strong need for an innovative lead-free and low temperature moldable dielectric material also having satisfactory seals of mica-based composite to metals. These void-free seals have to effectively isolate the arc-producing metal inserts.

According to an aspect of the invention, a molding composite includes: mica flakes; and a eutectic glaze.

According to an embodiment of any paragraph(s) of this summary, the eutectic glaze has a lowest eutectic temperature of from 450° C. to 550° C.

According to an embodiment of any paragraph(s) of this summary, the eutectic glaze is in a fine powder, having an average diameter of 1 to 10 microns.

According to an embodiment of any paragraph(s) of this summary, the eutectic glaze is a multi-oxide glaze that includes multiple glaze-forming oxides.

According to an embodiment of any paragraph(s) of this summary, the glaze-forming oxides include at least one oxide of an alkali metal.

According to an embodiment of any paragraph(s) of this summary, the glaze-forming oxides include at least one oxide of an alkaline earth.

According to an embodiment of any paragraph(s) of this summary, the molding composite includes one or more additional additives.

According to an embodiment of any paragraph(s) of this summary, the molding composite includes a binder.

According to an embodiment of any paragraph(s) of this summary, the molding composite includes an additional additive to achieve a desired thermal coefficient of expansion.

According to an embodiment of any paragraph(s) of this summary, the molding composite includes an additional additive to achieve a desired thermal conductivity.

According to an embodiment of any paragraph(s) of this summary, the molding composite includes an additional additive to achieve desired electrical properties.

According to an embodiment of any paragraph(s) of this summary, the composition of the molding composite is 30 to 70% by weight mica flakes, and 30 to 70% by weight eutectic glaze.

According to an embodiment of any paragraph(s) of this summary, the molding composite is as part of a housing for an electrical and/or optical piece.

According to an embodiment of any paragraph(s) of this summary, the molding composite is as part of a support for one or more electrical conductors.

According to another aspect of the invention, a method of making a molded part includes the steps of: mixing together mica flakes and a eutectic glaze to form a molding composite; melting the eutectic glaze by subjecting the molding composite to elevated pressure and elevated temperature, thereby wetting the mica flakes with the eutectic glaze; and following the melting, shaping the molding composite into a desired shape.

According to an embodiment of any paragraph(s) of this summary, the method includes following the shaping, solidifying the molding composite.

According to an embodiment of any paragraph(s) of this summary, the solidifying the molding composite includes compressing the molding composite at a constant temperature until the eutectic glaze solidifies.

According to an embodiment of any paragraph(s) of this summary, the solidifying the molding composite includes compressing the molding composite at a constant elevated temperature until the eutectic glaze solidifies.

According to an embodiment of any paragraph(s) of this summary, the shaping the molding composite includes compression molding the molding composite.

According to an embodiment of any paragraph(s) of this summary, the melting the eutectic glaze includes melting the eutectic glaze at a temperature between 450° C. to 550° C.

According to an embodiment of any paragraph(s) of this summary, the mixing includes the mica flakes and the eutectic glaze.

According to an embodiment of any paragraph(s) of this summary, the method includes, after the mixing and before the melting, wetting the mica flakes and the eutectic glaze to form a wet mixture.

According to an embodiment of any paragraph(s) of this summary, after the wetting, compacting the wet mixture.

According to an embodiment of any paragraph(s) of this summary, after the compacting, drying the wet mixture.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a high-level flow chart of a method of making a molded part from a molding composite, according to an embodiment of the invention.

FIG. 2 is a photograph illustrating high uniformity of the mica-glaze molded composite.

FIG. 3 is a photograph showing details of the interfaces between the glaze and mica in a molded composite.

FIG. 4 shows spectroscopy results analyzing the composition of a molded composite part.

FIG. 5 is a photograph showing the interface between the mica-glaze composite and a metal insert.

FIG. 6 is an oblique view of an electronic circuit molded substrate, according to an embodiment of the invention.

FIG. 7 is an oblique view of a structural supporting member for supporting electrical conductors, according to another embodiment of the invention.

FIG. 8 is an oblique view showing a housing made of molded composite, according to yet another embodiment of the invention.

FIG. 9 is an oblique view of a laser crystal that may be housed in the housing of FIG. 8.

FIG. 10 is an oblique view of another housing made of a molded composite, according to an embodiment of the invention.

### DETAILED DESCRIPTION

A molding composite includes mica flakes and a eutectic glaze. The composite allows making of lead-free parts for use in a variety of situations, such as electrical insulators for supporting electrically-conductive parts, such as electrodes, for electrical devices. The molded composite material can be used mold around such electrically-conductive parts, supporting them and/or providing hermetic seals around the parts. Other possible uses include substrates for electronic circuits, and housings for parts, such as electro-optical parts and laser crystals.

The molding composite is heated under elevated pressure to liquefy the eutectic glaze, causing it to coat the mica flakes. After the composition of blended mica particulate and molten glaze is put into a desired shape it is solidified, for example by compressing the molding composite at a constant temperature until the eutectic glaze solidifies, followed by cooling of the molding composite.

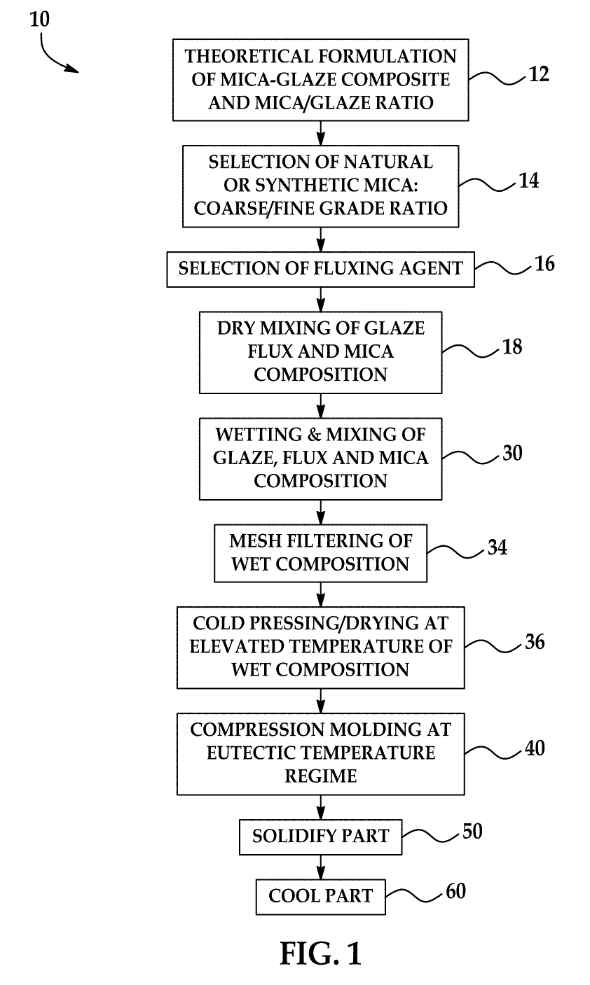

FIG. 1 shows a high-level flow chart of a method 10 for making a part from a molding composite. In step 12 a theoretical formation of a mica-glaze composite can be selected, with a mica/glaze ratio also determined. The determination may be made based on desired material properties for the molding compound. Since the mica does not melt like glaze frit, the preheated mix must be soft to adsorb the powder. The selected ratio of glaze and mica constituents is reflected in design of parts to be molded, so these ratio are different for the rounded or flat parts, and different for the flat and box-type housings.

Then in step 14 a selection is made regarding the mica to be used. The mica can be natural or synthetic, and may have a coarse and/or fine grade ratio. Commercially natural mica flakes are sized in fine, medium and coarse grades. These grades represent mica scrap ground into sizes ranging from 2 mesh to 30 mesh. The flakes of fine, medium, and coarse grades are 2, 10, and 16 mesh respectively. In the case of so-called fine powders of mica, the fine, medium, and coarse grades are 30, 60, and 100 mesh, respectively. These sizes are also applicable for the synthetic mica. Depending on the application and mold processing the selection of flakes and/or fine powders may be made. The goal may be to have the maximum packing density of dry and dry/wet suspension prior to the compression molding. The properly prescribed dry mix of fine and coarse grades particulates allow to get the higher packing density of particulate aggregate. The packing density of aggregates may be substantially higher under wet conditions than dry conditions.

At a proper ratio the coarse and fine mica particles form the dense system of packing. Although the oxides of mica are known to provide some fluxing, in (optional) step 16 an additional fluxing agent may be chosen. Fluxing agents such as potassium silicate may be used to promote melting.

In step 18 there is a dry mixing of the mica, the eutectic glaze powder, and the fluxing agent. Dry mixing of mica flakes may be done first, including the coarse and fine particulates (flakes and/or powder) in an appropriate ratios to achieve the desired material properties. The fluxing agent then can be added to this dry mix of mica flakes (and/or powder). The concentration of the fluxing agent may vary from 1 to 3% by mass, to give a non-limiting range.

Mica and glaze flakes and/or powder may then be blended, in step 30, in an aqueous medium (water), along with the fluxing agents. Additionally the mixture can include binders (materials such as nitro-cellulose or methyl-methacrylate, to give two examples), if desired. The metal components (the eutectic glaze powder) may then be added to the mixture. This fully blends together the ingredients of the molding compound or composite. As noted above, the main ingredients are mica flakes and a eutectic glaze, and other additives may be included in the molding composite.

Another possible additive is a magnetic material, such as ferrites, to fabricate a material suitable for radio frequency (RF) applications or other applications in which it would be desirable for the material to have magnetic properties. Such materials often have Curie point exceeding 650° C., for example including iron, cobalt, their alloys, and other such suitable. Some of these magnet materials have coefficients of thermal expansions (CTEs) that are similar to those of other constituents of the molding composite, such that a dense composite can be molded with small residual thermal stress. The ability to mold dielectric-magnet inserts devices of relatively complicated shape can be useful for the field of RF antennas.

The mica flakes may include large (coarse) high-aspect-ratio mica natural or synthetic flakes, for instance being rectangular in shape with 200 to 300 microns length/width in the planar direction or smaller and 20 to 40 micron thick. These values are only examples of suitable mica flakes, and should not be considered as limiting. The mica may be present in the mixture in a concentration that makes it sufficient not only as a major constituent of the molding composite, but as a thermal flux for the eutectic glaze as well. In other words, the mica may additionally serves as flux, playing the same role as soda, potash, magnesia or lime additives for the melting eutectic glaze phase.

The eutectic glaze may be any of a variety of suitable materials. The material may be in the form of fine frits, which may be fused and then granulated ceramic compositions. The frits may be powdered frits of a low-fire type eutectic glaze or glaze ceramics. The size powder for the frits may vary from 1 micron (fine powder option) to about 50 microns (coarse powder option), or may include frits having an average diameter from 1 to 10 microns. A eutectic is the lowest common melting point of two or more materials, which individually have melting points higher than that of their mixture frit. For example, while silica melts at 1710° C. and lead oxide melts at 880° C., a mixture of equal parts silica and lead oxide (50/50%) melts at about 800° C., which is a lower temperature than the melting points of both oxide constituent materials. The melting temperature of the eutectic material may be brought even lower by selecting different relative amounts of the silica and lead oxide, for example being approximately 510° C., for a mixture of 90% lead oxide and 10% silica. The eutectic point for the well-known industrial glazes are established by their phase diagram. The eutectic point for the specifically formulated glaze has to be established in a sequence of metallurgical experiments defining beginning of melting. More broadly, the eutectic material may have a lowest eutectic melting temperature of from 450° C. to 550° C., although this range is just a non-limiting example. The co-molding process temperatures may depend on the eutectic point of the prescribed glaze. In the case of the already-formulated glazes these temperatures may be known, as they reflect the eutecticity. Molding temperatures may be as high as 950° C., to give a non-limiting example. The co-molding process temperatures can be altered or experimentally established from a different standpoint, such as the optimum viscosity for the molten glaze, for example to obtain a desired ability to flow when form a mold and a working range for an applied low molding pressure.

Different oxide glazes as the eutectic glaze behave in similar fashion causing melting at a variety of temperatures for different ratios of constituents. The mica that is in the mixture may act to simulate a eutectic metallurgical reaction. In broad terms the fluxing agent and the mica itself affect and stimulate melting of the oxides. Moreover the flux (the mica) can and often does react with the constituent oxides of the glaze frits. Thus the eutectic formulation of glaze and mica flux/filler creates eutectics and forms a uniform composite.

The selection of suitable glazes may be based on their properties, and a necessity for processing at a suitable temperature. The targeted glazes desirably include glaze-forming oxides, glass-oxide modifiers, and fluxes reducing the melting temperatures. They can also include the alkali metals (e.g., Li, Na, K) and the alkaline earths (e.g., Mg, Ca, Sr, Br). Possible glazes for use in some situations include commercial pottery- and electronic-grade eutectic glazes. When the dielectric properties are important, such as in the opto-electronic applications, electronic-grade commercial glazes may be preferable. For other situations, such as for making a simple dielectric housing, a pottery-grade commercial glaze may be sufficient for the electrical isolation of contents of the housing.

A non-limiting example of a suitable low-temperature-firing glaze is EG 3018 glaze, available from Ferro Corporation of Mayfield Heights, Ohio, USA. Such a glaze may be suitable for most opto-electronic applications. Other Ferro glazes that may be suitable include glazes EG 2922 and EG 2934. EG 3018 is in the composition family Bi—Zn—B—RO, EG 2922 is in the composition family Bi—Zn—Si, and EG 2934 is in the composition family Bi—Zn—B—R₂O, where R in these formulations represents an alkaline earth component.

These are only examples of some of the lead-free eutectic glazes that can be used to make composites. Other suitable lead-free eutectic glazes may be used as alternatives.

The composite material may have ingredients or components in addition to the eutectic glaze and the mica flakes (and/or powder). For example the composite material may have a binder that helps hold the ingredients or components of the composite material together. The binder may be a resinous material, for example. Examples of suitable binders are PAN-31 and PAN-250, both of which are produced at ADEKA Fine Chemical Co. Some inorganic binders are also capable of withstanding very high molding temperatures, such as 700° C. and higher. Such inorganic binders often include carbon black, and synthetic and natural graphite matrix.

Other additives may be included in order to control one or more properties of the molding composite material. For example it may be desirable for the molding composite to attain a desired coefficient of thermal expansion. This may be done to match (within some degree of difference) the thermal expansion coefficient of another material which will be a component of the device of which the molding composite material will be a part, such as a metal part or insert co-molded with the molding composite material. For example metals and/or alloys co-molded with the molding composite material may have a coefficient of thermal expansion that is from 8 to 13 ppm, with the metal part or insert being made from 17-4 PH stainless steel, or titanium alloys, for example. Alternatively (or in addition) an additional material may be added to get the molding composite material to more closely simulate the properties of some prior-used molding compound, such as a prior molding compound that included lead. The additives to control properties may be selected, and the amount added may be selected, so as to achieve any of a variety of properties, such as working temperature, thermal expansion coefficient, dielectric coefficient, and/or thermal conductivity, to give a few examples. The additives may also be selected to control dielectric properties. For example a composite may be formulated to be useful for electro-optic applications and electronics. Such a material may be usable for different radio-frequency (RF) applications as well. The RF electromagnetic interactions may be controlled for different bands of radiation, for example from megahertz (MHz) through gigahertz (GHz) frequencies. The matched properties may include permittivity and permeability, the details on electrical resonance behavior, and the relaxation effects, including the characterization of relaxation times. In the radio frequency and microwave regime, the materials for RF application are the composites having co-molded magnetic particulates or magnetic inserts (e.g., strips of material). The magnetic materials may be selected from those having Curie point that is certainly exceeding the above said molding temperatures or eutectic point of glaze constituent. For example, the ferrites well withstand not only to 550° C., but to 650° C. Another example is iron, cobalt, their alloys and several others materials. The moldable dielectric-magnetic composites may enable different configurations of the miniaturized antennas having moderately large dielectric constant of mica-glaze (about 5) and a low magnetic loss particulates of traditional alpha ferrites, as well as NiZn and BaCo ferrites. The moldable antenna may be optimized for different frequency bands, including the lower UHF spectrum of 300-500 MHz.

For devices that include metal parts amid the molding compound, with interfaces between the two, the behavior of surface plasmons generated on such co-molded interfaces may be of particular concern in choosing properties of the molding compound. Additionally RF heating, wave cloaking, and polaritonic surface wave propagation effects may require the selection of additives to achieve desired properties. For example such a characterization may be important for uses involving plasmonic antennas. These antennas may be used to shift the performance to a visible band of electromagnetic spectrum. The ability to co-mold and therefore interface the dielectric matrix with the thin film conductors allow fabrication the micro and nano-antennas.

Non-limiting examples of suitable additives for controlling properties of the molding composite are thermoplastic or thermosetting polymers. In addition one or more eutectic glazes may be selected and/or varied in amount to achieve desired effects on the properties of the molding composite.

Following the wet mixing the wet composition may be filtered in step 34. This may be done in order to eliminate lumps. Following the filtering, the composition may be subjected to compaction and drying in step 36. This is a cold compaction that puts the material into a preform shape. Such a preform shape may be referred to as “green preform,” since the material has not yet been subjected to elevated temperatures. This green preform is obtained using pressures in the range of 13.8 to 20.7 MPa (2000 to 3000 psi). The preform thus obtained is allowed to cure and dry under ambient conditions. Slightly elevated temperatures of the order of 100 to 120° C. may be used to accelerate the drying process. The cure may be done for a period up to 30 days.

In step 40 the molding composite is subjected to elevated pressure and temperature in a transfer molding process, so as to melt the eutectic glaze. The temperature and pressure that would be necessary to accomplish this depends on the chemical formulation and properties of the eutectic glaze, and of the molding composite more generally. It will be appreciate that a range of temperatures and pressures may be used to melt the eutectic glaze, with different temperatures required depending on the pressure used in the process. The temperature and pressure may be selected taking into consideration the desired molding process, such as molding for a certain shape of final piece. For example the temperature may be as high as 950° C. (or more). The molding process-related pressure may varies from 3.45 to 34.5 MPa (500 to 5000 psi) on each cavity area of the mold and depends on the configuration of the moldable devices. The pressure may be chosen to ensure precise tolerances of the moldable devices. For moldings containing a metal insert an applied pressure is typically 2-3 times higher than when no insert is present. The pressure should not be so high as to cause mold cracking or damaging. The actual dimensions may play a role and influence the selection of the pressure and temperature. The flow-ability of the blended preform (molding compound to be used in the molding process) is one factor affecting the temperature of compression molding. In the case of proposed mica-glaze mixture, the temperature will generally be at least the lowest eutectic temperature of the glaze that is used. In order to improve the micro-heterogeneity of the mica-glaze composite the process temperatures may exceed the eutectic temperature by about 50-80° C., or by another suitable amount.

The pressure and temperature may be applied in a rigid die representing the configuration to be molded. In one embodiment a hot-working steel die is used. Although high-temperature alloys may be used as an alternative, the ability to use a low-cost die is one advantage of the eutectic-based processing.

If the phase diagram is known, all the (multiple) eutectic points may be well defined, and the heating cycle may be organized and optimized to achieve full melting of the glaze. When a glaze-mica composite blend is heated, the first eutectic combinations will melt first. Once fluid, the melted material will soak into the fluxing agent and mica. This process continues until the whole mass of glaze constituent is molten.

It is advantageous for the glaze to be completely melted in the process, since if the melting is incomplete, the melted portions of the glaze will have a different composition than the unmelted portions. The melted portions will produce a eutectic glaze. In the case of multi-oxide eutectic glazes, the firing cycle may include various eutectics, and may be developed upon the formulation of the desirable mica-glaze compositions. Different compositions therefore require different firing cycles corresponding to the phase diagram of the selected glaze. In the case of multi-oxide eutectic glazes, the pressure used in the process may reflect the above firing cycles, as well.

In one example embodiment, the process includes the following stages. The dry glaze powder, for example Ferro EG 3018, is premixed with a fluxing agent in 10:1 weight ratio. The suitable fluxing agent is potassium fluorosilicate or similar material. This operation forms a glaze-flux dry mix. In order to form a second dry mix the coarse and fine grades of synthetic or natural mica are mixed in a ratio that is suitable for the certain shapes of molded devices. This ratio may be varied from 10:1 to 1:1, to give non-limiting example values. After that the two dry mixes are mixed together. The obtained homogeneous dry mix is then wetted by water to form the moldable slurry. The typical mix-water weight ratios vary from 10:1 to 5:1, so the slurry has a moldable consistency.

The formed slurry is then filtered through a mesh to eliminate lumps. The slurry is then dispensed to a mold and compressed at room temperature, as described above. The compressed preform can be subjected to a room temperature drying cycle for 4-24 hours, depending on size and shape. The dried preforms in the mold are then subjected to a low elevated temperature cycle. This may done in a suitable oven, and for suitable period of time, such as (for example) for 2-20 hours, or for days. The thermally dried material is finally subjected to a eutectic temperature thermal cycle. The transfer molding to the desired shape takes place during this thermal cycle. The glaze is melting and flow covers all mica flakes. Mica and a fluxing agent in turn provide an additional fluxing for the metallurgical reaction between the mica and glaze constituents.

The melting of the eutectic glaze, and its wetting of the mica flakes, provides many specific advantages. The reduced viscosity of glaze when molten is associated with improved wetting and very good structural bonding with the mica constituent. Also the reduced pressure during subsequent compression molding (relative to molding processes using prior materials) enhances the ability the molding of units of complicated configuration with good structural integrity of the co-molded metal sub-components. The glazes are present in the particulate frits (solid state) or in the melted state when they preheated to the eutectic temperature. The reduced viscosity when the glaze is molten refers not just to the liquid material itself, but also to particulates or granular media in the liquid material. In the case of solid mica and molten glaze we have a viscous (non-linear) suspension. The rheological properties of that suspension, including its viscosity, depend on mica particle size, particle size distribution for its fractions, and the volume fraction of different fractions of solid mica present in that suspension. The viscosity of molten glaze is a second factor that affects the effective viscosity of mica-glaze suspension. Thus viscosity is often used in modeling liquid-solid suspensions. The flow and deformation of suspension in mold depends on the pressure applied to certain mold configuration. The flow of mica-glaze suspension is function of its rheological properties, deformation rate, volume fraction of particulates, and properties of molten glaze phase. All these factors, as well as the configuration of the mold, are factors in the desirable pressure for the molding process. The molded material may also make a solid structural connection with metal inserts or with other parts with which the molded material is in contact.

The melting and wetting help in minimizing voids in the molded material. Void-free interfaces between mica and glazes are achievable, with consequent improved dielectric properties and arcing resistance.

The molding composite is shaped to form a desired shape of a part configuration. This may be done in a compression molding process or the like, specifically a compression melt molding. The molded material may be formed around other parts, such as metal electrodes, terminals, inserts and reinforcement units.

In step 50 the molded part is solidified. This solidification of the whole part occurs even at high temperatures (at the eutectic point and below), which may reduce residual stresses and warpage due to the cooling of a molded unit with homogenous and limited shrinkage. Then the part may be cooled, in step 60.

The solidification process of melted glaze in close proximity to solid mica flake differs dramatically from the conventional mica-glass composites. In particular, this difference can be summarized as the following. Melting the glaze takes time. The liquid formation (glaze) facilitates mobility of oxides. The greater melt fluidity provided by more time and temperature affords more molecular mobility. Given sufficient freedom to move, the molecules will arrange themselves in an increasingly preferred matrix and cooling will freeze this as a solid. Diffusion of ions within the melt of glaze improves the uniformity. The well-melted glazes are more chemically uniform than other (previous) glasses. Raw glaze melting starts at eutectic temperature, which is always lower than the respective melting temperatures of the oxides forming the glaze. Melting starts at the mica boundary making the interface well wetted and nearly void free. Thus by understanding how the eutectic glazes melt, one can formulate the composite materials and determine behavior and temperature of melting and test the degree of melt. Combining this with the details of compression molding, an exact fabrication process incorporating melting of eutectic phase to a compression molding of it when blended with mica can be performed in a desirable way.

The process 10 integrates the molding and the phase change processes. The details of the process 10 include selection the molding process parameters (temperature profile, pressure, estimated effective viscosity, anticipated shrinkage, etc.), which may affect dielectric and thermal properties, as well as dimensional accuracy of the molded parts. The process may also involve slightly increased holding time for reaching a uniform heating within the melt, until pressure is applied. This may generate parts with low residual stresses and high dimensional accuracy.

In contrast to regular glasses, the eutectic glazes are characterized by the low temperature processing facilitated by the eutectic reaction, and the relatively low viscosity, which positively contributes to molding and co-molding. Additionally the glaze can provide some coloring options that can be associated with the optical performance of crystals to be housed inside the mica-glaze composite. Furthermore, the mica flakes when blended with the eutectic glazes and subjected to low temperature firing may add a sparkle effect to the surface of some composites, which may be advantageous.

The above-described co-molding involves two major constituents: the eutectic glaze and the mica. (Other possible ingredients are the fluxing agent, the water, and the binder.) At the eutectic temperature the glaze melts. The viscosity of the molten glaze is a viscosity of a liquid, while mica is a solid particulate, which can have fine, medium, and/or coarse mica flakes and/or mica powder. This is in contrast to conventional glasses (or mixed oxides) that are solids, so the mix of glass and mica is characterized by very high effective viscosity. The compression molding of such conventional mixes therefore will require much higher pressure that the above-described mixture of eutectic glaze and mica. The liquid glaze provides sufficient flow at relatively low pressure applied to a slurry in mold. Both the external pressure and the capillary effect facilitate the filtration of the molten constituent (the eutectic glaze) between the moderately compressed particulates. The capillary effect referred to here is the capillary effect between adjacent particles of mica, with surface tension able to aid the flow of the molten glaze. Use of mica flakes of different dimensions can aid the dense packing, as well as this capillary effect, with smaller mica flakes aiding in filling in the gaps between larger mica flakes. When the gaps are filled with the fine powder the dimensional parameters of the capillaries between the adjusted particles become very small and the surface tension helps in flow of the molten glaze.

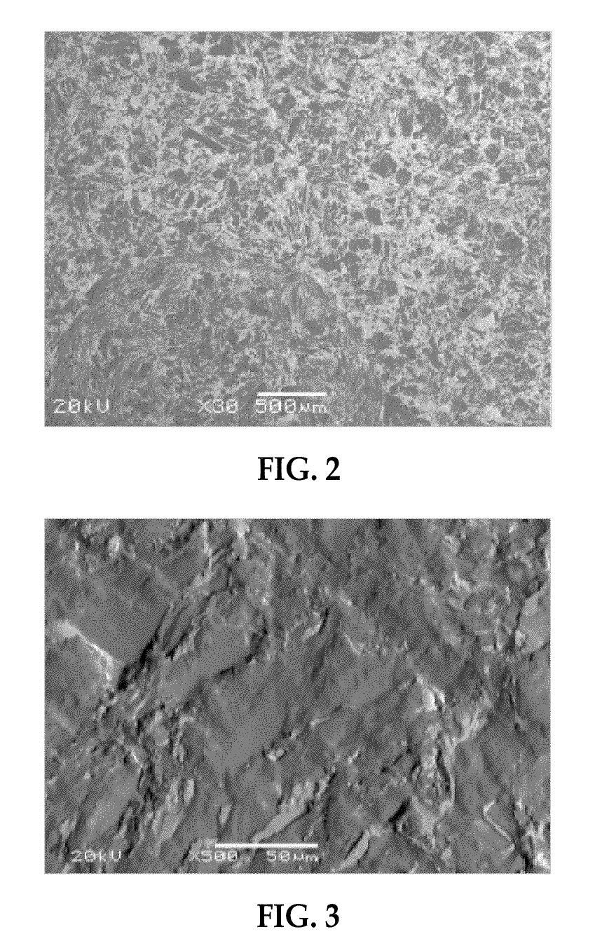

FIGS. 2-5 show various aspects of the structure of a composite part made with the molding composite. FIG. 2 illustrates high uniformity of the mica-glaze composite. The figure shows a scanning electron microscope (SEM) image taken at 30×, showing large mica flakes molded in with glaze. The formed composite has minimal macro-defects. The molten eutectic glaze has flowed well into the space between the neighboring flakes of mica, with a homogeneous phase distribution.

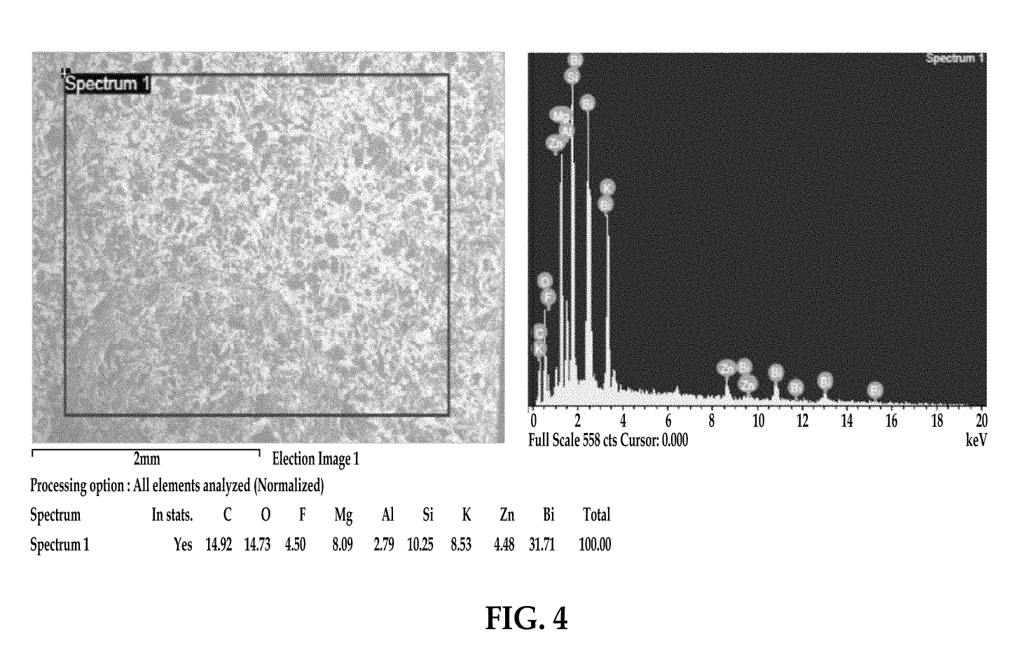

FIG. 3 shows details of the interfaces between the glaze and mica at a higher magnification (500×). This clearly shows void-free interfaces and an innovative type of phase interaction. The fluxing by the mica has stimulated the eutectic metallurgical reaction between the oxides in the glaze and the mica. This material interaction is confirmed by FIG. 4, which shows results obtained by means of spectroscopy. The spectra shows the elements present within all the constituent oxides and the traces of the additional metals and oxides, which are present in the natural mica flakes and glaze.

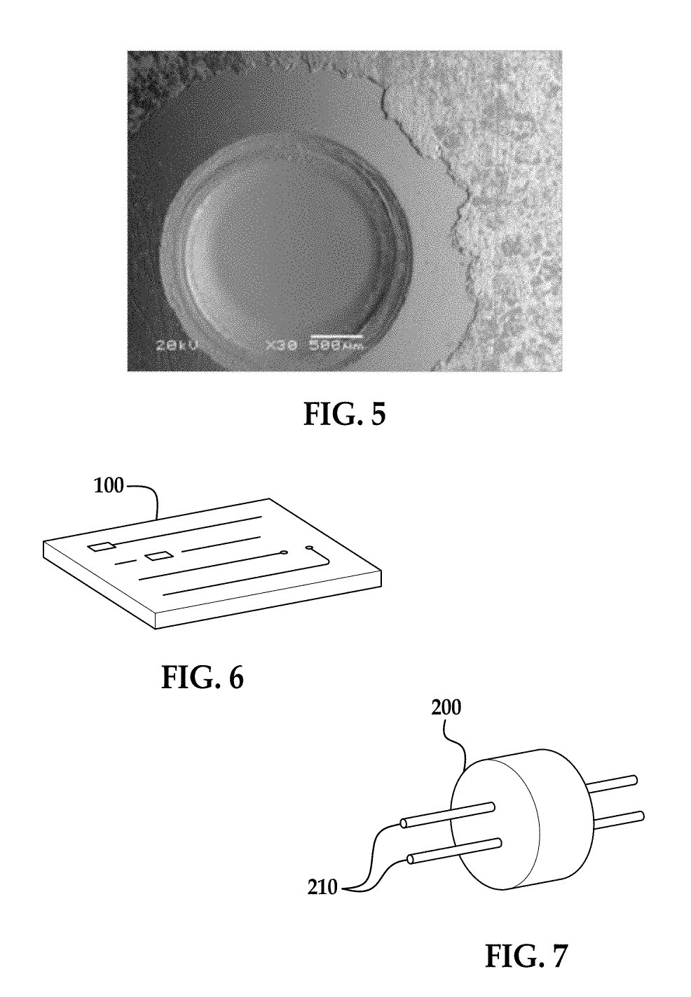

FIG. 5 shows the high-quality interface between the mica-glaze composite and a metal insert (the large round object in the figure). The melted glaze phase and fluxing mica produced good flow around the insert, resulting in a void-free composite-insert interface.

Other advantages for parts made from the process 10 include parts with reduced residual stress, low-viscosity composites that make the material more flowable, and thereby that ease molding, ready machinability, and better sealing with other parts in contact with the composite material.

The mica and glaze constituents may be blended together in ratios (weight percentages) varied from 30% to 70% and from 70% to 30%, respectively. More specifically, the glaze-mica ratio (weight percentage of the two) may be about 40% glaze to 60% mica, such as being 35-45% glaze and 55-65% mica. These values are non-limiting examples, and other values may be used instead. The various formulations of mica-glaze form a family of different dielectric and thermally insulating composites.

Different uses may call for different formulations to achieve different properties. In the case of thin-walled box type housings, the optimized composites can have the larger concentrations of glaze, for example up to 70% (weight percentage) of the mica-glaze combined weight. In the case of flat circuit board type devices, a higher concentration of mica may be preferable instead. The blending can be accompanied with another additive stimulating the molding and forming a high performance composite. The amount of additive has to be sufficient to uniformly coat these fine particles by dry blending. A compaction and forming is applied to densify and aggregate the mica and glaze and shape the mixture. An example of an additive is potassium fluorosilicate, which may be used in a concentration of from 1 to 5% by weight (of the weight of the combined ingredients of mica, eutectic glaze, and additives).

The process 10 may be used to make molded products with any of a variety of properties and uses, able to satisfy criteria in different fields of use. To give one example, the molded composite part may be an electronic circuit substrate, such as the substrate 100 shown in FIG. 6. This mica-glaze composite is suitable for use as a substrate material for electronic circuits in high-temperature and optical applications, particularly where complex geometries are required. With the ability to co-mold terminals and conductors, the mica-glaze allows for simplified manufacturing and processing, and the machinability of the mica-glaze allows for precise final dimensions.

Another example of a use for the molding composite is an electrically and/or thermally insulating member, and/or as a structurally supporting member, such as the support 200 shown in FIG. 7. The support 200 may be used for high-voltage applications such as terminals and conductors. Due to its high-temperature resistance, the support 200 may also be used as an electrical insulator or as a support for heating elements. This material can also be used as an insulator for electric filaments. In the illustrated embodiment, the support 200 is used to support a series of electrical conductors 210.

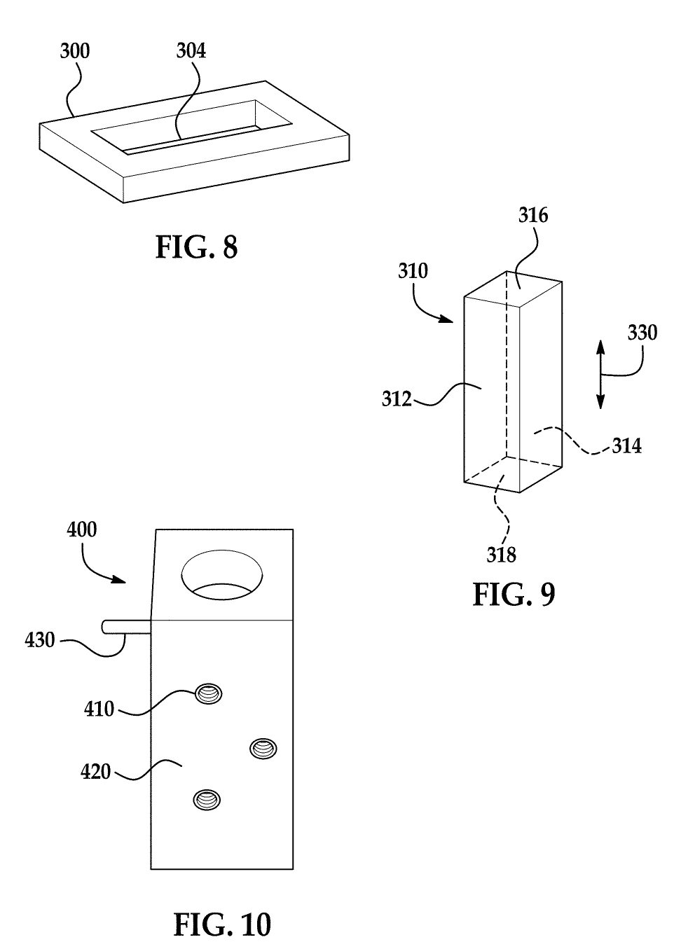

FIG. 8 shows another possible use for the molding composite, as part of a housing 300 for an optical device, such as a laser switch, for example a prismatic LiNbO₃ laser Q-switch crystal that is used in a forward-looking infrared sensor. The housing 300 defines a cavity 304 for receiving the optical device. An example of such a laser crystal 310 is shown in FIG. 9. The grown, poled and well-polished crystal 310 of LiNbO3 includes two metalized lateral surfaces 312 and 314, for example having gold metallization, and end faces 316 and 318 including anti-reflection optical coatings. The device relates to electro-optic Q-switching process that can be used to periodically modulate the light in a laser cavity of an infrared sensor. In particular, the crystal 310 forms a Pockel cell. From an engineering standpoint these cells are encapsulated prismatic or cylindrical devices consisting of LiNbO3 crystal 310 with the electrodes attached to it. The crystal 310 is passively aligned and housed inside the mica-glaze box type enclosure. When a light beam propagates though the longitudinal axis 330, the phase delay in the crystal 310 can be modulated by applying a variable voltage to metallization. The cell thus can act as a voltage-controlled wave-plate. These crystals having high damage resistant antireflective coatings located on the end faces allow for different high energy operations with high repetition rates (say in the KHz region). In general these cells perform a number of electro-optic applications, such as switching, pulse picking, shuttering, and phase modulating. In all these operations the cells transfer the deposited electro-magnetic field devices. In all the designs the electrodes are typically located on the sides and the beam propagates longitudinally along the axis 330. Although these the most versatile and well-developed active optical crystals have good mechanical and chemical stability its fluency resistance often depends on the quality of crystal-housing-electrode interface. The mica-glaze housing provides the required operational reliability.

The Q-switch generates a high intensity, pulsed laser light when combined with Nd:YAG, Nd:YLF and other type solid state lasers. When properly shaped, polished, poled, mounted and aligned, the crystals operate with the low loss, having also high contrast ratio, and low wave-front distortion. When properly encapsulated to a mica-glaze housing having stainless steel electrodes, the Q-switches exhibit temperature-stable operations over a wide range of thermo-optical parameters. With the nearly perfect composite-metal interface, the electrical failures are excluded. The LiNbO₃ switches are typically used in the defense applications, including the targeting devices, designators, range-finding devices etc. The feasible medical applications include the ophthalmic and dermatology surgery applications. Co-molding composites with such devices (and other metal inserts and/or terminals) may help avoid arcing and electrical malfunction (electrical leakage), thereby improving the operational reliability and protecting the laser crystal or other device.

FIG. 10 shows another housing, a housing 400, for housing an optical device, such as the laser crystal 310 (FIG. 9). The housing 400 may include a series of threaded inserts 410 that are co-molded along with the composite material 420. The composite material 420 may be compression molded with the inserts 410 placed at appropriate positions within the mold, to be secured in place by the molded composite material 420. Other sorts of inserts, such as metal pins or terminals, for example a pin 430, may be put into place as part of the molding process, with the composite material molded around the inserts.

The composite material may have a color that is indicative of its composition and/or its properties. For example the solidified composite material may have a rose or yellow tint, which may be a function of different oxides in the finished piece, for example from the use of differing compositions of the mica glaze used. The different color may be used as an aid to identify the properties of the finished composite material piece.

The compositions, methods, and resulting parts may offer many advantages relative to previous efforts. Such advantages may include one or more of the following: ability to work under elevated operating temperature; dimensional stability; moderate-to-high compressive strength; strong thermal shock resistance; completely inorganic composite with no outgassing; impervious to moisture, oils, and gases; withstands moderate magnitude thermal cycling; high thermal insulation; high dielectric strength and low electrical loss; high arc resistance; vacuum-tight sealing; and/or can be bonded with epoxy, sealing glass, or ceramic adhesives. Mica-glaze composites such as described herein are ceramic-like composite materials in most of their thermo-mechanical properties. Being also moldable materials, they are also “ceramo-plastic,” in that they have properties are similar to those of ceramics, but are moldable like a plastic material. In other words a mica-glaze composite mixture may be pressed into a preform, heated to the eutectic temperature to make the glaze flow, and then transfer-molded or compression-molded to the desired shape. In most cases the products do not require final machining. The estimated thermal-expansion coefficient of mica-glazes may be close to that of low expansion metals and alloys. This property, along with its extremely low shrinkage during molding, allows metal inserts to be molded into the composite and also ensures close dimensional tolerances. The metal-reinforced devices can be easily fabricated as well.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A molding composite comprising:
mica flakes; and
a eutectic glaze.

2. The molding composite of claim 1, wherein the eutectic glaze has a lowest eutectic temperature of from 450° C. to 550° C.

3. The molding composite of claim 1, wherein the eutectic glaze is in a fine powder, having an average diameter of 1 to 10 microns.

4. The molding composite of claim 1, wherein the eutectic glaze is a multi-oxide glaze that includes multiple glaze-forming oxides.

5. The molding composite of claim 4, wherein the glaze-forming oxides include at least one oxide of an alkali metal.

6. The molding composite of claim 4, wherein the glaze-forming oxides include at least one oxide of an alkaline earth.

7. The molding composite of claim 1, prcccding claims, further comprising one or more additional additives.

8. The molding composite of claim 1, further comprising a binder.

9. The molding composite of claim 1, further comprising an additional additive to achieve a desired thermal coefficient of expansion.

10. The molding composite of claim 1, further comprising an additional additive to achieve a desired thermal conductivity.

11. The molding composite of claim 1, further comprising an additional additive to achieve desired electrical properties.

12. The molding composite of claim 1, wherein the composition of the molding composite is 30 to 70% by weight mica flakes, and 30 to 70% by weight eutectic glaze.

13. The molding composite of claim 1, as part of a housing for an electrical and/or optical piece, or as part of a support for one or more electrical conductors.

14. A method of making a molded part, the method comprising:
mixing together mica flakes and a eutectic glaze to form a molding composite;
melting the eutectic glaze by subjecting the molding composite to elevated pressure and elevated temperature, thereby wetting the mica flakes with the eutectic glaze; and
following the melting, shaping the molding composite into a desired shape.

15. The method of claim 14, further comprising, following the shaping, solidifying the molding composite.

16. The method of claim 15, wherein the solidifying the molding composite includes compressing the molding composite at a constant temperature until the eutectic glaze solidifies.

17. The method of claim 15, wherein the solidifying the molding composite includes compressing the molding composite at a constant elevated temperature until the eutectic glaze solidifies.

18. The method of claim 14, wherein the shaping the molding composite includes compression molding the molding composite.

19. The method of claim 14, wherein the melting the eutectic glaze includes melting the eutectic glaze at a temperature between 450° C. to 550° C.

20. The method of claim 14, wherein the mixing includes the mica flakes and the eutectic glaze; and
further comprising, after the mixing and before the melting:
wetting the mica flakes and the eutectic glaze to form a wet mixture;
after the wetting, compacting the wet mixture; and
after the compacting, drying the wet mixture.
